(19) United States
(12) Patent Application Publication
(10) Pub. No.: US 2009/0122024 A1
(43) Pub. Date: May 14, 2009

(54) Display Device Provided With Optical Input Function

(76) Inventors: Takashi NAKAMURA, Saitama-shi (JP); Takayuki Imai, Fukaya-shi (JP); Hirotaka Hayashi, Fukaya-shi (JP); Hiroki Nakamura, Ageo-shi (JP); Masayoshi Fuchi, Ageo-shi (JP); Masahiro Tada, Tokyo (JP); Hiroyoshi Murata, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/260,656

(22) Filed: Oct. 29, 2008

(30) Foreign Application Priority Data
Oct. 30, 2007 (JP) 2007-281735
Jul. 8, 2008 (JP) 2008-178020

(51) Int. Cl. G06F 3/041

(52) U.S. Cl. 345/173

(57) ABSTRACT

In a display device, an object approaching a display unit is detected by referring to an image picked up by the display unit. An alternating current drive circuit drives an alternating current signal to the display unit, so that a detection circuit detects an amplitude change or a phase shift. Alternatively, a liquid crystal panel is vibrated at a predetermined frequency, so that the strength of the frequency of the vibration sound is detected. This makes it possible to more accurately detect the timing when the object touches the display unit.

### CROSS-REFERENCE TO RELATED APPLICATIONS

This application is base upon and claims the benefit of priority from Japanese Patent Applications No. 2007-281735 filed on Oct. 30, 2007, and No. 2008-178020 filed on Jul. 8, 2008; the entire contents of which are incorporated herein by reference.

### BACKGROUND OF THE INVENTION

1. Field of the Invention

The present invention relates to a display device provided with an optical input function for obtaining information from a display screen by using light.

2. Description of the Related Art

In recent years, a liquid crystal display device has been widely used for various devices such as a cellular phone and a laptop computer as a display device. The liquid crystal display device includes a display unit and a drive circuit. In the display unit, a plurality of scan lines and a plurality of signal lines are arranged in a matrix and are intersected with each other. In addition, pixels, each of which includes a thin film transistor, a liquid crystal capacitor and an auxiliary capacitor, are provided respectively to the intersections of these lines. The drive circuit drives each scan line and each signal line. A display device has been developed which includes photosensors arranged in pixels, and which thereby is capable of obtaining information from a display screen by using light. For example, there is one described in Japanese Patent Application Publication No. 2006-133788.

In such a display device having an optical input function, for example, photodiodes are provided as photosensors respectively in pixels, and a capacitor is connected to each of the photodiodes. The amount of charge in each of the capacitors is changed according to the amount of light received by the corresponding photodiode. Thus, by detecting voltages of the capacitors, a picked-up image of an object adjacent to a display screen can be obtained.

As an application of such a display device having an optical input function, a device incorporating a touch panel function or a digitizer function has been proposed. The touch panel function allows a user to input information to the device by detecting a shadow of an object such as a finger, which is projected onto a display screen. The digitizer allows a user to input information to the device by detecting light radiated from an illuminating object such as a light pen.

However, in the case of such a conventional display device having an optical input function, the contact between the object and the display screen is determined only based on the image thus picked up. Therefore, ambient light conditions sometimes makes it difficult to distinguish a case where a finger actually touches a display screen, form a case where the finger is merely in the air above the display screen. This leads to an incorrect input.

### SUMMARY OF INVENTION

The present invention has been made in view of the foregoing situation, and aims to improve accuracy in determining whether or not an object touches a display screen in a display device having an optical input function.

An aspect of the present invention provides a display device including: an image display unit configured to display an image on a display screen; an optical input unit configured to pick up an image of an object adjacent to the display screen; a coordinate calculator configured to calculate position coordinates of the object by using the picked-up image; a driver configured to apply any of an electric signal and physical vibration to the display screen; a detector configured to detect a change in any of the electric signal and the vibration applied to the display screen; and a contact determination unit configured to determine, based on the change, whether or not the object touches the display screen.

According to the aspect of the present invention, including: the optical input unit configured to obtain a picked-up image of an object adjacent to the display screen of the display device; the driver configured to apply any of an electric signal and physical vibration to the display screen; and the detector configured to detect a change in the electric signal or the vibration, the display device is capable of determining a contact of an object, on the basis of not only the picked-up image of the object adjacent to the display screen, but also a response concerning the electric signal or the physical vibration that changes due to the contact of the object with the display screen. This makes it possible to more accurately detect the timing when the object touches the display screen.

### BRIEF DESCRIPTION OF THE DRAWINGS

FIG. 1 is a plan view showing a configuration of a display device according to a first embodiment of the present invention;

FIG. 2 is a cross sectional view showing a configuration of a display unit of the display device;

FIG. 3 is a circuit diagram showing a configuration of a pixel of the display device;

FIG. 4 is a plan view showing the configuration of the pixel of the display device;

FIG. 5 is a block diagram showing a configuration of a circuit formed on an array substrate of the display device;

FIG. 6 is a circuit diagram showing a configuration of a photosensor circuit and an A/D converter circuit in the pixel of the display device;

FIG. 7 is an explanatory diagram showing a flow of a process of a contact determination;

FIG. 8 is a circuit diagram showing a configuration of a detection circuit of the display device;

FIG. 9 is a graph showing an alternating current signal V0 applied to a conductive layer of the display device, and an alternating current signal V1 detected therefrom;

FIG. 10 is a circuit diagram showing a configuration of another detection circuit of the display device;

FIG. 11 is a circuit diagram showing a configuration of still another detection circuit of the display device;

FIG. 12 is a circuit diagram showing a configuration of a noise filter of the detection circuit shown in FIG. 11;

FIG. 13 is a circuit diagram showing a configuration of a rectifier and comparator of the detection circuit shown in FIG. 11;

FIG. 14A is a graph showing an alternating current waveform in a node A of the detection circuit shown in FIG. 11;

FIG. 14B is a graph showing an alternating current waveform in a node B of the detection circuit shown in FIG. 11;

FIG. 14C is a graph showing an alternating current waveform in a node C of the detection circuit shown in FIG. 11;

FIG. 14D is a graph showing an output from the detection circuit shown in FIG. 11;

FIG. 15A is a cross sectional view showing a configuration of a protective plate of the display device;

FIG. 15B is a diagram showing a state where the protective plate is pressed with a finger;

FIG. 15C is a diagram showing a state where the protective plate is pressed with a stylus pen;

FIG. 16 is a graph showing an alternating current signal V0 applied to the conductive layer of the display device, and an alternating current signal V1 detected therefrom;

FIG. 17 is a graph showing a relation between a distance from the finger to a display panel, and a phase delay to be detected;

FIG. 18 is a plan view showing a configuration of conductive layers formed on a protective plate of a display device according to a second embodiment of the present invention;

FIG. 19 is timing chart showing timings at which the conductive layers of the display device are driven to perform output;

FIG. 20 is an explanatory diagram for explaining a state where the display device detects that multiple fingers touch the protective plate;

FIG. 21 is a diagram showing signals detected when two fingers touch two points on the display device;

FIG. 22 is a plan view showing another configuration of conductive layers formed on the protective plate of the display device according to a second embodiment;

FIG. 23 is a plan view of the display device having a configuration of collectively driving the multiple conductive layers formed on the protective plate of the display device shown in FIG. 22;

FIG. 24 is timing chart showing timings when the conductive layers of the display device shown in FIG. 23 are driven to perform output;

FIG. 25 is a plan view showing a configuration of conductive layers and an active area formed on a protective plate of a display device according to a third embodiment of the present invention;

FIG. 26 is a plan view showing a state where fingers touch points inside and outside the active area of the display device;

FIG. 27 is a plan view showing the conductive layers in each of which a contact is detected in the case of FIG. 26;

FIG. 28 is a diagram showing an image picked up in the case of FIG. 26;

FIG. 29 is a plan view showing a configuration of a display device according to a fourth embodiment of the present invention;

FIG. 30 is an explanatory diagram showing that a display panel is vibrated;

FIG. 31 is an explanatory diagram showing that a finger touches the display panel when the display panel is vibrated;

FIG. 32 is a graph showing a relation between a distance from the finger to a protective plate, and an amplitude of an vibration frequency component to be detected; and

FIG. 33 is a graph showing a relation between a strength of pressing the protective plate by the finger and the amplitude of the vibration frequency component to be detected.

### DESCRIPTION OF THE EMBODIMENTS

### First Embodiment

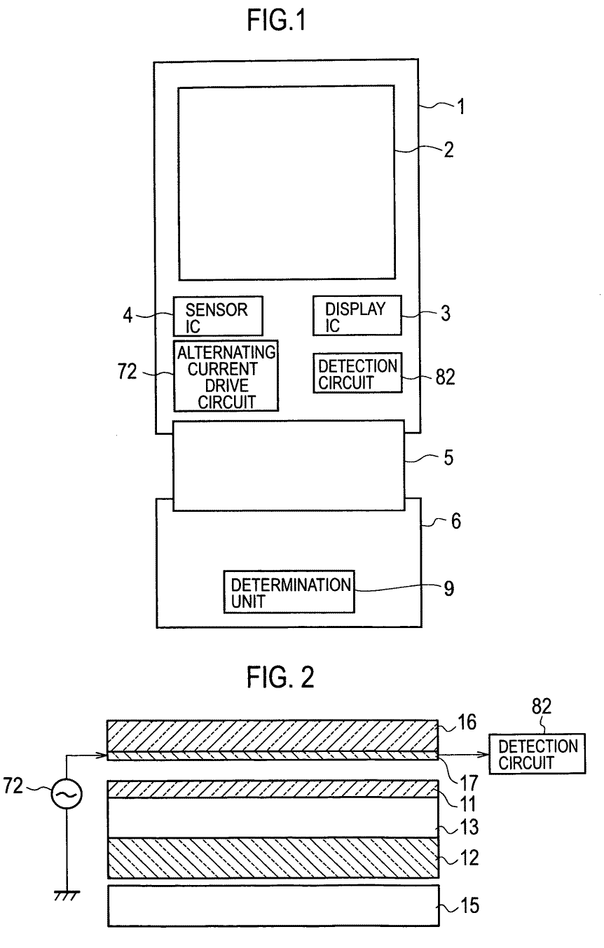

A display device shown in FIG. 1 includes a liquid crystal panel 1 and a host substrate 6. The liquid crystal panel 1 and the host substrate 6 are connected to each other through a flexible substrate 5.

The liquid crystal panel 1 includes a display unit 2, a display IC (Integrated Circuit) 3, a sensor IC 4, an alternating current drive circuit 72 and a detection circuit 82. The display IC 3 and the sensor IC 4 are mounted on the liquid crystal panel 1 by using the Chip on Glass (COG) technique, and are connected to the host substrate 6 through an interface. The display unit 2 includes a display function that displays an image, and an optical input function that images an object approaching the display unit 2 and obtains the image. The display IC 3 controls the display unit 2 on the basis of an image signal transmitted from the host substrate 6 to display an image. The sensor IC 4 controls the display unit 2 to obtain a picked-up image, analyzes the picked-up image, detects the coordinates, approach information of an object approaching the surface of the liquid crystal panel 1, and then outputs them to the host substrate 6. The optical input function of the display unit 2 will be described in detail later.

The alternating current drive circuit 72 drives an alternating current signal to the liquid crystal panel 1. The detection circuit 82 detects an amplitude change or a phase shift of the alternating current signal thus driven to the liquid crystal panel 1. By detecting the amplitude change or the phase shift, a determination is made as to whether or not a pointing object such as a finger touches the liquid crystal panel 1. The host substrate 6 includes a determination unit 9. The determination unit 9 makes such a contact determination based on the amplitude change or the phase shift thus detected. The contact determination will be described in detail later.

The host substrate 6 includes the determination unit 9 that is shown, and further includes various types of circuits such as a central processing unit (CPU), a random access memory (RAM) and a read only memory (ROM). Furthermore, the host substrate 6 includes a communication module, a camera module or the like when the display device is used for a cellular phone.

As shown in FIG. 2, the liquid crystal panel 1 is configured to sandwich a liquid crystal layer 13 between an array substrate 11 and an opposite substrate 12. Outside the array substrate 11 and the opposite substrate 12, polarizing plates (not shown) are arranged, respectively. A backlight 15 is arranged adjacent to the opposite substrate 12. Signal lines and scan lines are arranged in a matrix on the array substrate 11. The display unit 2 is configured of pixels formed at the respective intersections of the pixel signal lines and the scan lines. A protective plate 16 is arranged on the surface of the array substrate 11 touched by the pointing object. The protective plate 16 includes a conductive layer 17 with ITO electrodes formed on the entire surface thereof at the side of the array substrate 11. The alternating current drive circuit 72 and the detection circuit 82 are connected to the conductive layer 17. The alternating current drive circuit 72 drives an alternating current signal to the conductive layer 17, and the detection circuit 82 detects an alternating current signal from the conductive layer 17. In addition, a transparent insulating material having a low dielectric constant is used for the protective plate 16.

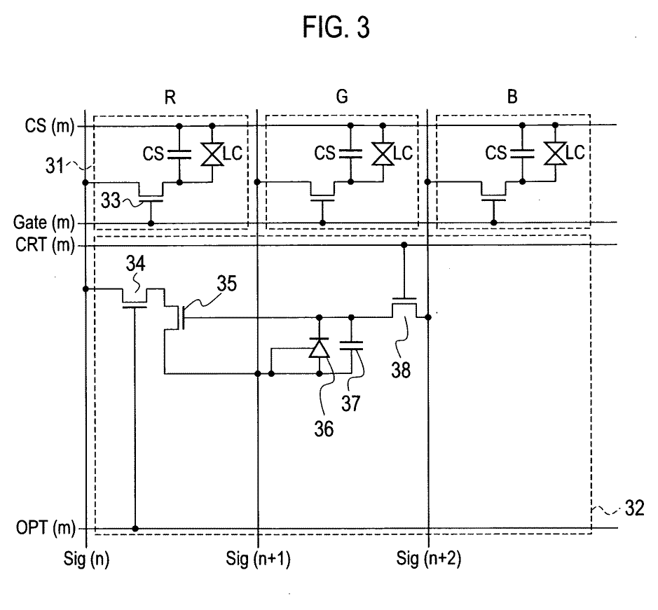

Next, descriptions will be given in detail of a configuration of a pixel of the display unit and the optical input function of the display unit. As shown in FIG. 3, each pixel is composed of a display circuit 31 having the display function and a photosensor circuit 32 having the optical input function. In the display unit 2, subpixels of red (R), green (G) and blue (B) are regularly arranged, and one pixel is composed of a set of one red subpixel, one green subpixel and one blue subpixel. Each of subpixels includes the display circuit 31 having a switching element 33, a liquid crystal capacitor LC and an auxiliary capacitor CS. In FIG. 3, Gate(m) and CS(m) denote a scan line and an auxiliary capacitance line, respectively, which are located in the m-th line, and Sig(n) denotes a signal line that is located in the n-th column. Each switching element 33 is an MOS type. A gate of the switching element 33 is connected to the scan line Gate, a source thereof is connected to the signal line Sig, and a drain thereof is connected to the auxiliary capacitor CS and the liquid crystal capacitor LC. The other end terminal of the auxiliary capacitor CS is connected to the auxiliary capacitance line. An image signal is transmitted from the host side to the switching element 33 through the signal line Sig. When the switching element 33 is turned ON in response to a scan signal transmitted to the scan line Gate, the image signal is given to the auxiliary capacitor CS and the liquid crystal capacitor LC through the switching element 33, and is then used for display.

In the display unit 2, one photosensor circuit 32 is provided to each set of three subpixels of R, G and B. The photosensor circuit 32 includes a photosensor 36, a sensor capacitor 37, and an output control switch 34, a source follower amplifier 35 and a precharge control switch 38. Here, as an example of the photosensor 36, a PIN type photodiode is used. The photosensor 36 and the sensor capacitor 37 are connected in parallel. Both of the photosensor 36 and the sensor capacitor 37 are connected to the signal line Sig(n) of the red subpixel through the source follower amplifier 35 and the output control switch 34, and are connected to the signal line Sig (n+2) of the blue subpixel through the precharge control switch 38. ON/OFF of the output control switch 34 is controlled by using a signal transmitted through a control line OPT (m). ON/OFF of the precharge control switch 38 is controlled by using a signal transmitted through a control line CRT (m).

Here, descriptions will be given of an operation of the photosensor circuit 32. First, the control line CRT (m) is held at a high level, so that the precharge control switch 38 is turned ON, and a precharge voltage applied to the signal line Sig (n+2) is precharged to the sensor capacitor 37. In this time, a reference voltage is applied to the signal line Sig (n+1). If a leakage current occurs in the photosensor 36 in a predetermined exposure time according to the amount of the light entering the photosensor 36, the potential of the sensor capacitor 37 changes. After a predetermined voltage (5V) is applied to the signal line Sig (n), the control line OPT (m) is set at a high level and the output control switch 34 is turned ON. The source follower amplifier 35 is turned ON and OFF according to the potential of the sensor capacitor 37 so that the potential of the signal line Sig (n) changes. The amount of the light having entered the photosensor 36 is detected based on the potential of the signal line Sig (n) in each pixel. This enables obtaining a picked-up image of the object adjacent to the display screen.

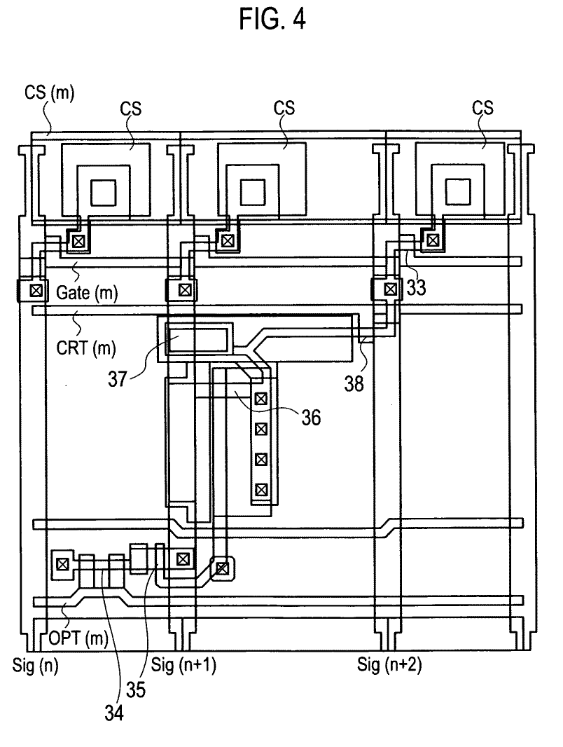

As shown in FIG. 4, one pixel is composed of a set of one red subpixel, one green subpixel and one blue subpixel in order from left. The length of each side of one pixel is 153 μm. Each of the control switches, the auxiliary capacitors and the like are formed of polysilicon on a glass substrate. The elements such as the photosensor 36 and the sensor capacitor 37 are not concentrated in a certain color subpixel, but are arranged dispersedly in all the subpixels. For the purpose of uniforming the opening degrees of the respective subpixels, the width of each subpixel is adjusted. The sensor capacitor 37 is formed of polysilicon and MoW (molybdenum-tungsten). In the sensor capacitor 37, a closer one of the electrodes to the glass substrate is used as a precharge node, whereas the other one is used as a GND node.

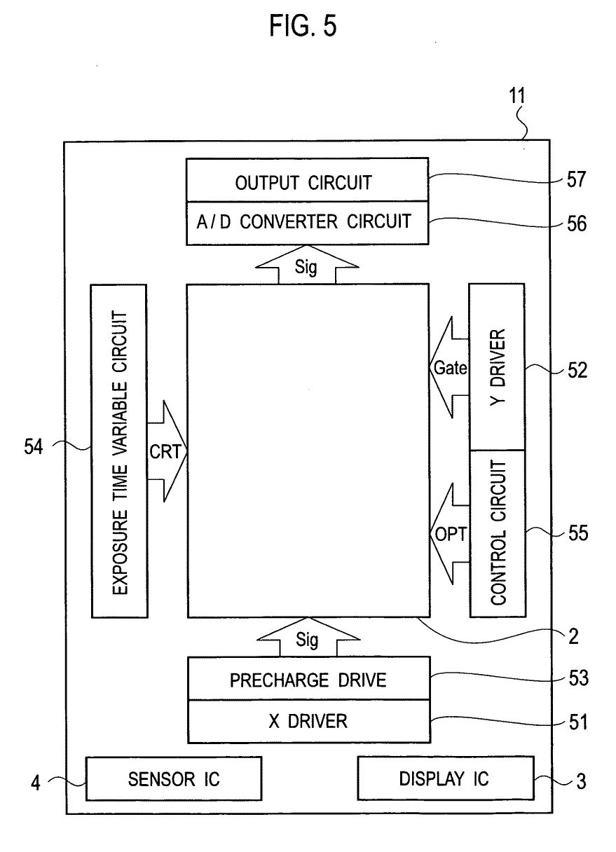

As shown in FIG. 5, the array substrate 11 includes thereon, in addition to the display IC 3 and the sensor IC 4, an X driver 51, a Y driver 52, a precharge circuit 53, an exposure time variable circuit 54, a control circuit 55, an A/D converter circuit 56 and an output circuit 57.

The X driver 51 outputs an image signal to each of the signal lines Sig arranged on the array substrate 11. The Y driver 52 controls ON/OFF of the switching element 33 arranged in each pixel through the corresponding scan line Gate, and writes the image signal outputted to the corresponding signal line Sig into each pixel.

The precharge circuit 53 applies a predetermined voltage to the signal line Sig by utilizing a horizontal blanking period during which both of the X driver 51 and the Y driver 52 are not writing an image, thereby operating the photosensor circuit 32. To be specific, the precharge circuit 53 applies the reference voltage, which is equivalent to GND of the photosensor circuit 32, to the signal line Sig (n+1), and applies the precharge voltage, which is for precharging the sensor capacitor 37, to the signal line Sig (n+2). The precharge circuit 53 applies the predetermined voltage (5V) to the signal line Sig (n). The precharge voltage and the reference voltage oscillate in phase with each other, approximately with a frequency of 50 Hz and an amplitude of ±0.5 V.

The exposure time variable circuit 54 controls the control line CRT (m) so as to turn ON and OFF the precharge control switch 38 arranged in each pixel. Thereby, the exposure time variable circuit 54 writes the precharge voltage applied to the signal line Sig (n+2) by the precharge circuit 53 into the sensor capacitor 37.

The control circuit 55 controls the control line OPT (m) so as to turn ON and OFF the output control switch 34 arranged in each pixel. Thereby, the control circuit 55 gives an output of each photosensor circuit 32 to the corresponding signal line Sig (n).

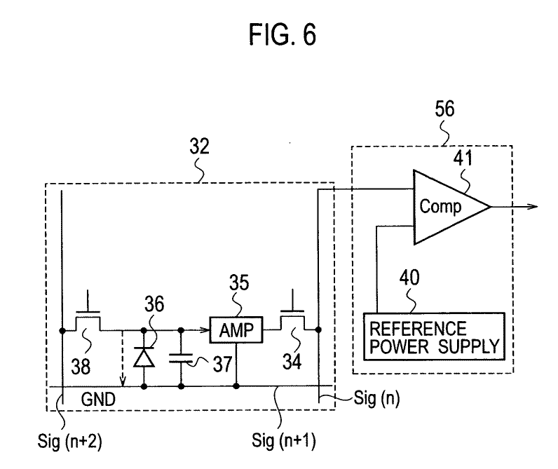

The A/D converter circuit 56 converts a signal, outputted by the photosensor circuit 32 through the signal line Sig (n), into a digital signal. The output circuit 57 outputs the converted digital signal to the sensor IC 4. To be specific, as shown in FIG. 6, a comparator 41 of the A/D converter circuit 56 compares the potential of the signal line Sig (n) with the reference potential of a reference power supply 40. Then, when the potential of the signal line Sig(n) is higher than the reference potential, the A/D converter circuit 56 outputs a high-level signal. On the other hand, when the potential of the signal line Sig(n) is lower than the reference potential, the A/D converter circuit 56 outputs a low-level signal. In other words, the comparator 41 outputs a high-level signal when detecting brighter light than a predetermined value. On the other hand, the comparator 41 outputs a low-level signal when detecting darker light than the predetermined value. Then, the sensor IC 4 receives the signal outputted from the comparator 41 through the output circuit 57.

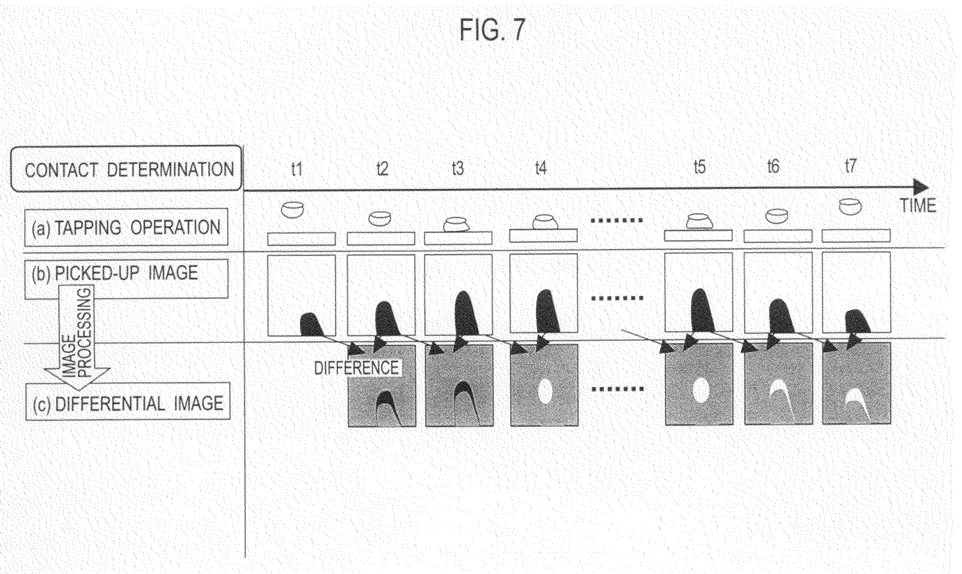

Next, description will be given of a process for a contact determination of an object. FIG. 7 depicts picked-up images taken when a user performs a tapping operation on the display unit 2 and differential images thereof. The sensor IC 4 receives a signal having a size corresponding to the amount of the received light from the photosensor circuit 32 formed on the display unit 2, thereby obtaining the picked-up images. Each of the differential images is an image representing the difference between two successive picked-up images which are captured respectively at two different times. In each differential image, a portion where there is no movement is expressed in halftone, and a portion where there is a movement is expressed in black or white.

The sensor IC 4 is capable of detecting that a finger is likely to be approaching the screen by analyzing the differential images. For example, when the sensor IC 4 detects a quick movement by an imaged object or a sudden gradation change in a part of the picked-up images, the sensor IC 4 determines that there is a high possibility that the object is approaching the display unit 2.

The position coordinates of the object in the display screen are calculated by using the picked-up images. For example, the position coordinates are calculated by obtaining the center of mass of the imaged object.

When the sensor IC 4 determines that the object is highly likely to be approaching the display unit 2, the alternating current drive circuit 72 applies an alternating current signal to one place of the conductive layer 17 during a vertical blanking period in the display unit 2. Then, the detection circuit 82 reads out the alternating current signal from another place of the conductive layer 17, and detects an amplitude change, a phase delay or the like. The determination unit 9 makes a contact determination based on the detected amplitude change, phase delay or the like. To be specific, the determination unit 9 determines that an object touches the display screen when the amplitude of the alternating current signal becomes small or when the phase delay is detected.

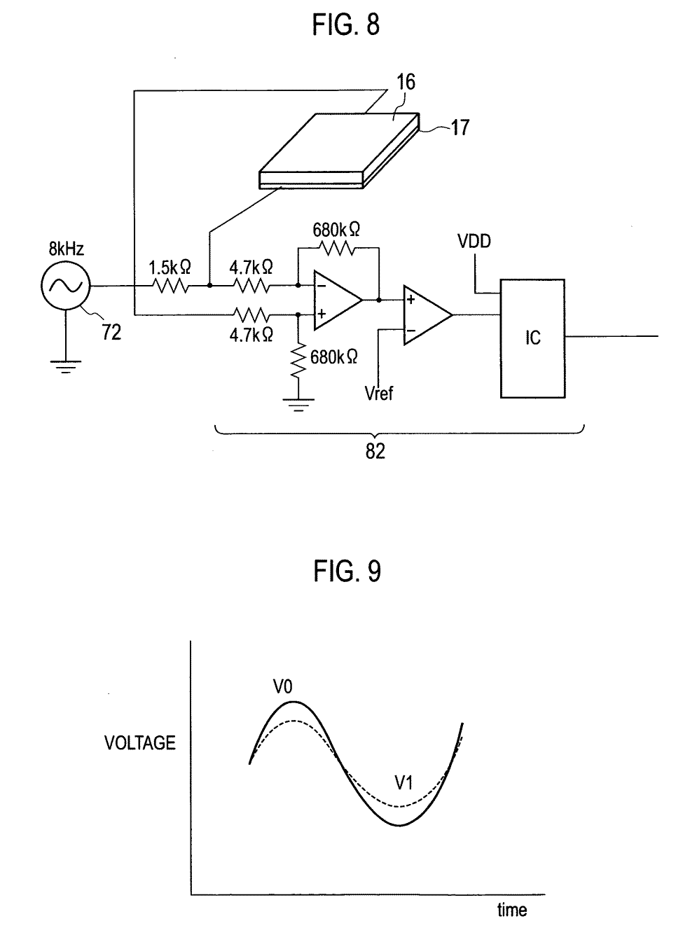

The detection circuit 82 shown in FIG. 8 includes an amplifier circuit, a comparator and a buffer IC. The amplifier circuit amplifies a potential difference between the alternating current signal applied to the conductive layer 17 and the alternating current signal with an amplitude attenuated depending on the state of the capacitance in the conductive layer 17. The comparator compares the potential difference and a predetermined threshold value Vref. The buffer IC counts pulses inputted during a predetermined time period, and stores the counted value in a register.

As shown in a graph FIG. 9, when an alternating current signal V0 is applied to the conductive layer 17 while a finger touches the protective plate 16, the detection circuit 82 detects an alternating current signal V1 with an attenuated amplitude. Whether or not the finger touches the protective plate 16 can be determined by amplifying a difference between the amplitudes of the applied alternating current signal V0 and the detected alternating current signal V1, and by determining whether or not the difference is larger than the predetermined threshold value Vref. When the finger does not touch the protective plate 16, there is almost no difference between the amplitudes of the alternating current signal V0 and the alternating current signal V1. On the other hand, when the finger touches the protective plate 16, capacitive coupling between the finger in contact with the protective plate 16 and the conductive layer 17 becomes large, and thereby the difference between the amplitudes of the alternating current signal V0 and the alternating current signal V1 becomes large.

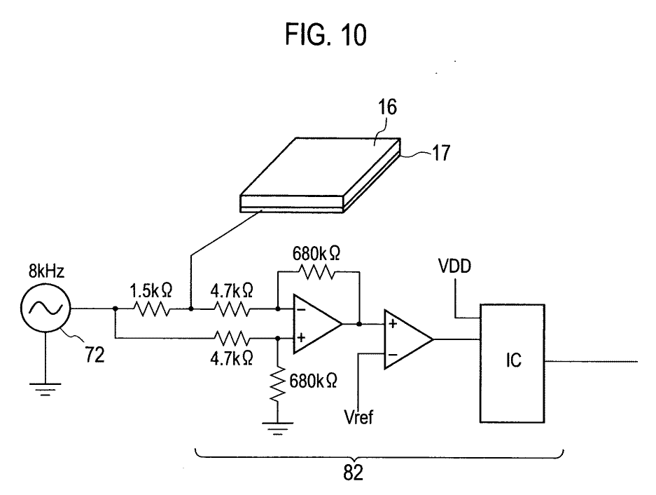

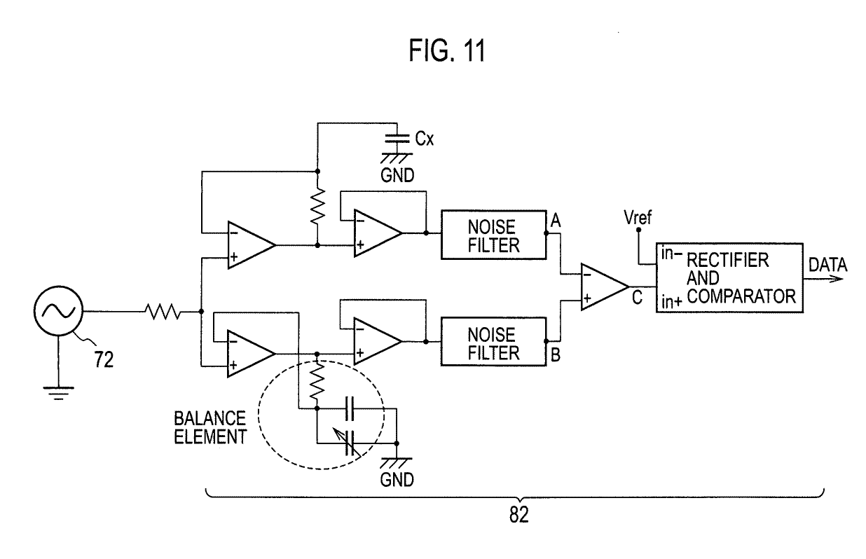

FIG. 10 is a circuit diagram showing a configuration of another detection circuit 82. The detection circuit 82 shown in FIG. 10 is different from the detection circuit 82 shown in FIG. 8 in that the former one has a smaller number of contact points with the conductive layer 17 than the latter one. FIG. 11 depicts a modified example of the circuit shown in FIG. 10. When a finger touches the protective plate 16, the finger and the conductive layer 17 are coupled with each other, thereby adding a coupling capacitance Cf to a capacitance Cx of the conductive layer 17. Furthermore, the capacitance Cx increases as the finger presses the protective plate 16 and the conductive layer 17 against the array substrate 11 (Cx+Cx2). In a node A, the alternating current signal detected in the conductive layer 17 is obtained. The alternating current signal thus detected varies depending on the capacitance Cx of the conductive layer 17. In a node B, the applied alternating current signal as a reference is obtained. In a node C, a difference signal is obtained by inputting the alternating current signals in the node A and the node B into a differential amplifier circuit. The resistance value and the capacitance value of a balance element are adjusted so that the difference signal can be as small as possible in a state where the finger is not adjacent to the protective plate 16. Alternatively, the frequency of the alternating current drive circuit 72, or the values of a gain and variable capacitance of the differential amplifier circuit may be adjusted. These values can be manually adjusted, or can be adjusted by an ASIC in reference to output DATA from a rectifier and comparator. The alternating current drive circuit 72, the detection circuit 82, the ASIC and the like can be integrated in one chip.

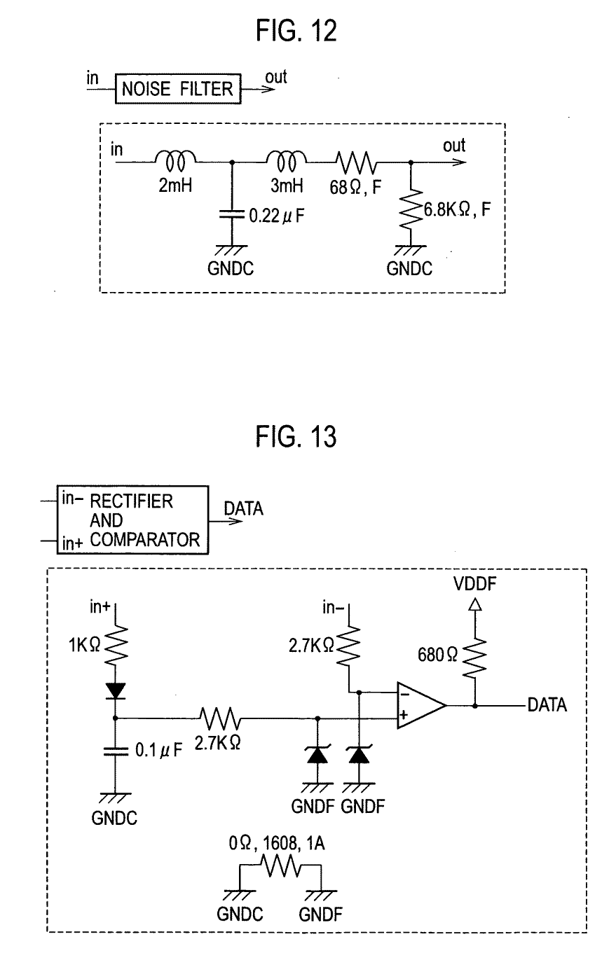

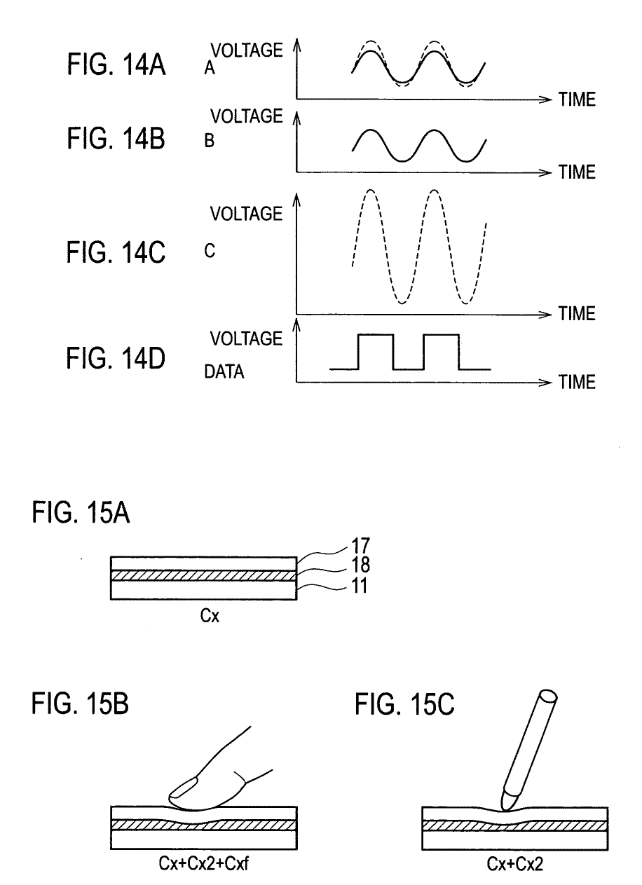

A noise filter for cutting high frequency noise from a liquid crystal cell and the back light 15 is arranged in each of the nodes A and B. FIG. 12 depicts a circuit diagram of the noise filter. FIG. 13 depicts a circuit diagram of the rectifier and comparator. The rectifier and comparator converts the analog difference signal into a digital signal, and outputs the digital signal to the host substrate 6. The rectifier and comparator may convert the analog difference signal into a binary digital signal, and outputs the binary digital signal, thereby identifying whether or not the finger touches the protective plate 16. Instead, for example, the rectifier and comparator may convert the analog difference signal into a digital signal having 256 gradation levels, and outputs the digital signal, thereby detecting whether or not the finger presses the protective plate 16 firmly, or whether or not the finger is approaching the protective plate 16 before contact. FIGS. 14A, 14B, 14C and 14D depict waveforms observed in the nodes A, B and C and the output DATA, respectively.

FIG. 15A depicts an example of an adhesive layer 18 thickly arranged between the protective plate 16 and the array substrate 11. Here, air is used as the adhesive layer 18. In other words, a space is provided between the protective plate 16 and the array substrate 11. As shown in FIG. 15B, when the finger presses the protective plate 16, the coupling capacitance Cf is added to the stray capacitance Cx of the conductive layer 17 (not shown), and the stray capacitance Cx increases approximately by a capacitance Cx2 depending on a change in the thickness of the adhesive layer 18. Hence, the space produces an advantageous effect of strengthening the difference signal detected in the node C in FIG. 11. Furthermore, as shown in FIG. 15C, when an input operation is performed by bringing a tapered tip of a stylus pen into contact with the protective plate 16, the sufficient coupling with the conductive layer 17 is expected not to be obtained. Even in this case, the detected difference signal changes according to the stray capacitance Cx that changes depending on the change in the thickness of the adhesive layer 18. In this way, even a contact of an object having a tapered tip such as a stylus pen can be determined.

When a contact determination is made by detecting the change in the thickness of the adhesive layer 18 as described above, the protective plate 16 is preferably composed of an acrylic material rather than a tempered glass. Because the contact coordinates can be detected based on the picked-up images taken by the optical input function of the display unit 2, a pen input by the stylus pen can be performed. To be specific, the pen input is performed in a way that the coordinates calculated from the picked-up images are coupled and thus displayed while a large difference signal is being detected in the node C.

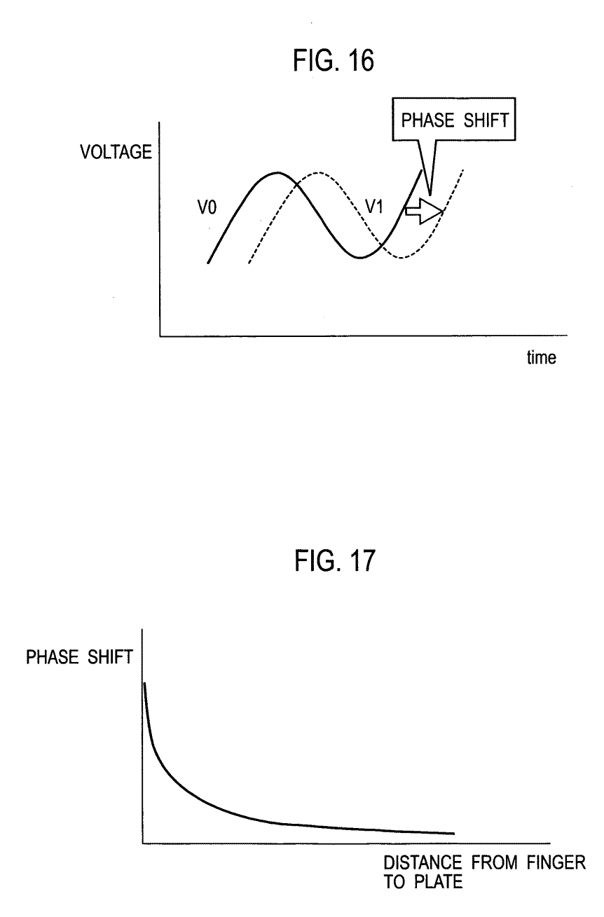

Otherwise, a contact determination can be made by detecting a phase shift, instead of the amplitude. As shown in a graph in FIG. 16, when the finger is in contact with the protective plate 16, the phase of the detected alternating current signal V1 lags behind the phase of the applied alternating current signal V0. Thus, a contact determination between the finger and the protective plate 16 can be made by detecting this phase shift. FIG. 17 is a graph showing a relation between a distance from the finger to the protective plate 16 and the phase delay to be detected.

Note that the alternating current signal is applied only for a predetermined time period (for example, approximately one second) after the appearance of a sign indicating that the pointing object is approaching, thereby power consumption can be reduced.

In the present embodiment, an alternating current signal is driven to the conductive layer 17 formed on the protective plate 16. Instead, an alternating current signal may be driven to the signal lines Sig of the liquid crystal panel 1 or the opposite electrodes formed on the entire surface of the opposite substrate 12.

Therefore, according to this embodiment, an object approaching the display unit 2 is detected by referring to the images picked up by the photosensor circuit 32 of the display unit 2, and an amplitude change or phase shift is detected by driving an alternating current signal in the conductive layer 17. This enables more correct detection of the timing when the object touches the display unit 2.

According to this embodiment, it can be determined that an object is in contact with the display unit 2 if the amplitude change or phase shift of an alternating current signal driven in the conductive layer 17 is detected while the alternating current signal is driven to the conductive layer 17. This makes it possible to detect not only the moment when the object touches the display unit 2, but also the state where the object is in contact with the display unit 2 (state where the object continuously presses the display screen).

According to this embodiment, an object approaching the display unit 2 is detected by referring to the image picked up by the photosensor circuit 32 of the display unit 2. This makes it possible to detect not only the contact coordinates, but also the position coordinates of the object approaching the display unit 2.

### Second Embodiment

A display device according to a second embodiment of the present invention includes a conductive layer 17 which is obtained by dividing the conductive layer 17 of the display device in the first embodiment into multiple patterns. The sensor IC 4 is configured to obtain the position coordinates of multiple objects adjacent to the display unit 2. However, with the configuration in which the conductive layer 17 is formed on the entire surface of the protective plate 16, the sensor IC 4 cannot determine whether each of the multiple objects touches the protective plate 16. In a display device according to the second embodiment, the conductive layer 17 is divided into multiple patterns so that a contact determination of each of multiple objects can be made.

The display device in the second embodiment has approximately the same basic configuration as that of the display device described in the first embodiment. Hereinafter, descriptions will be given mainly of the conductive layer 17 having a configuration different from that in the first embodiment.

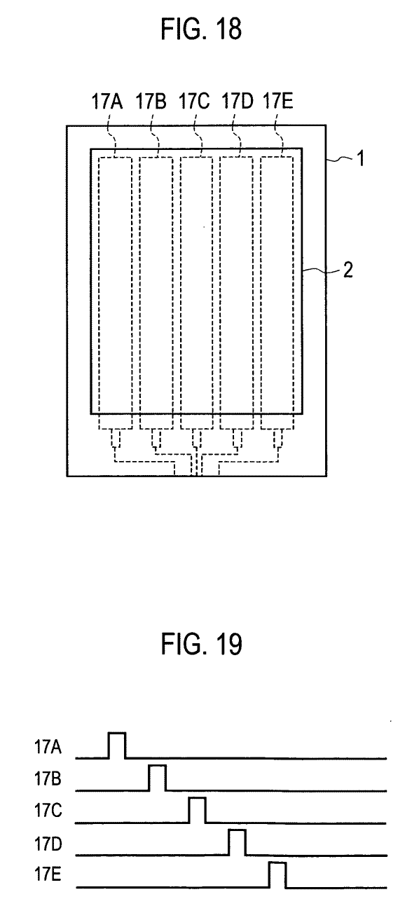

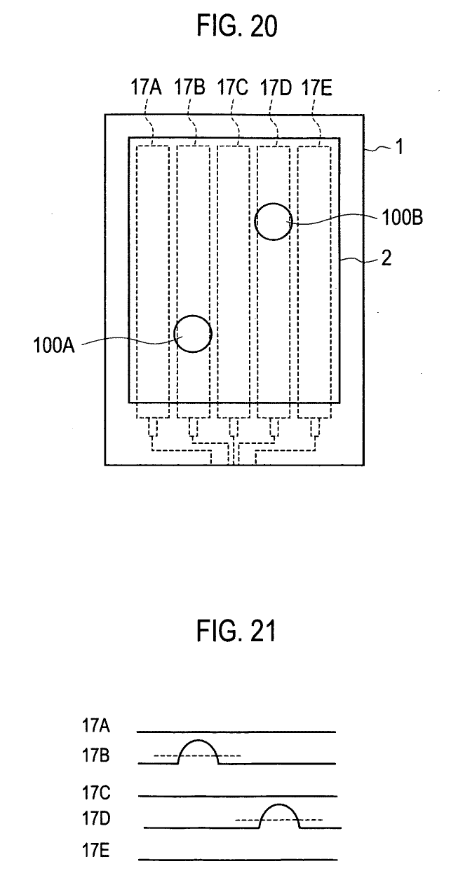

As shown in FIG. 18, a display device according to the second embodiment includes conductive layers 17A, . . . , and 17E of multiple patterns divided inside a protective plate 16 (on a liquid crystal layer side). The conductive layers 17A, . . . , and 17E are each formed of a separate ITO electrode. The conductive layers 17A, . . . , and 17E are driven to perform output respectively at different timings, as shown in FIG. 19. For example, as shown in FIG. 20, when fingers 100A and 100B touch two points of the protective plate 16 corresponding to the conductive layers 17B and 17D, respectively, the detection circuit 82 detects each change of the capacitive coupling in each of the conductive layers 17B and 17D as shown in FIG. 21. In this manner, the detection circuit 82 is capable of detecting a change of the capacitive coupling in each of the multiple conductive layers 17A, . . . , and 17E, so that a contact determination can be made for each of multiple objects. Using picked-up images, a sensor IC 4 obtains the contact coordinates of each of the fingers 100A and 100B touching the protective plate 16. At this time, the sensor IC 4 corrects a positional deviation of the contact coordinates that are calculated by using approximate position information of the conductive layers 17A, . . . , and 17E in each of which a contact of an object is detected. In the above-described example, the conductive layers 17A, . . . , and 17E are formed arranged in a horizontal direction. Alternatively, the conductive layers 17A, . . . , and 17E may be formed arranged in a vertical direction. Otherwise, the conductive layers 17A, . . . , and 17E may be formed in a matrix of the vertical and horizontal directions.

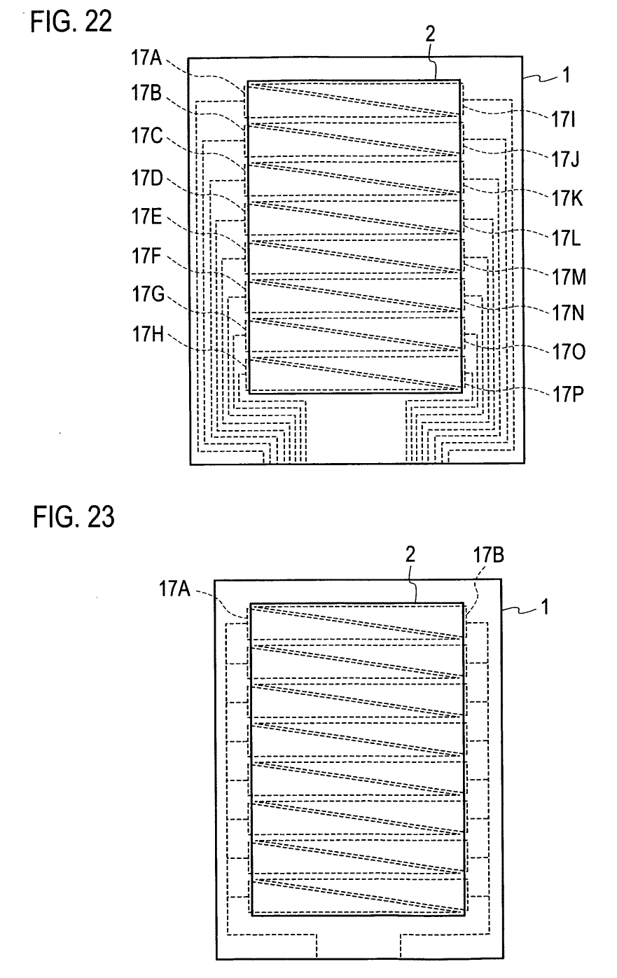

A display device shown in FIG. 22 includes conductive layers 17A, and 17P of sixteen divided patterns. In this case, as in the case described above, each of the divided conductive layers 17A, . . . , and 17P is driven to output individually.

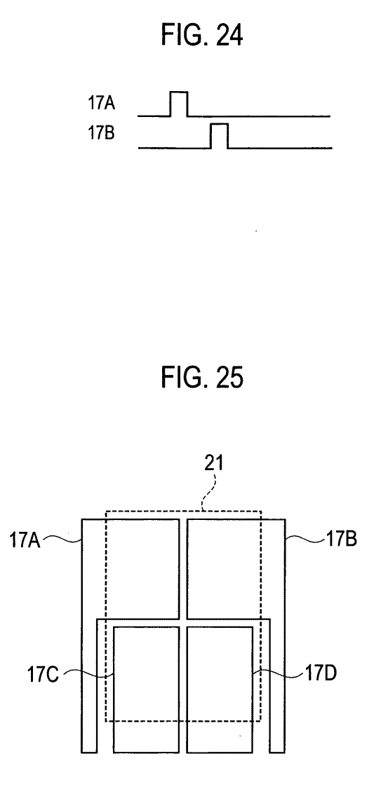

Conductive layers shown in FIG. 23 are those divided in the same manner as shown in FIG. 22. The conductive layers on the right side are combined as a conductive layer 17A. The conductive layers on the left side are combined as a conductive layer 17B. As shown in FIG. 24, the conductive layer 17A and the conductive layer 17B are driven to perform output in this order.

Therefore, according to the present invention, the conductive layer for detecting a contact of an object is divided into multiple patterns, thereby enabling a detection of contact of each of multiple objects with the protective plate 16. Thus, the sensor IC 4 is able to calculate the contact coordinates of the multiple objects.

According to the invention, the conductive layer for detecting a contact of an object is divided in multiple patterns, thereby enabling a correction of a positional deviation of the contact coordinates calculated by using approximate position information of the conductive layers in each of which a contact of an object is detected.

### Third Embodiment

A display device according to a third embodiment of the present invention has approximately the same basic configuration as that of the display device described in the second embodiment. A display device shown in FIG. 25 includes conductive layers 17A, 17B, 17C and 17D of four divided patterns. In an active area 21, a photosensor is formed in each pixel.

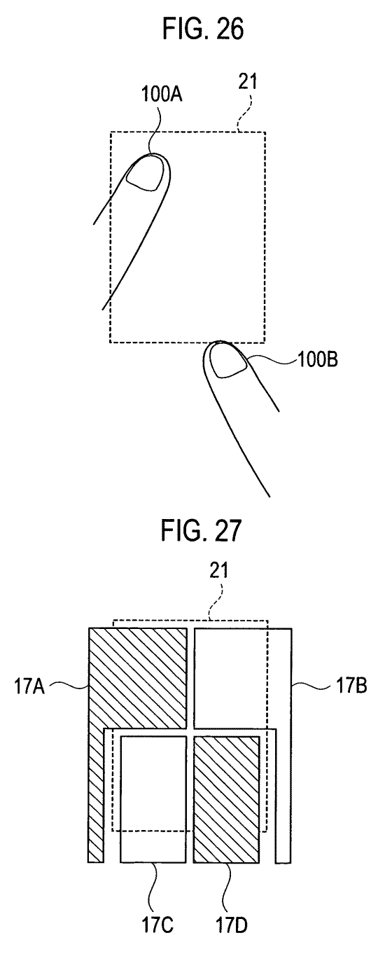

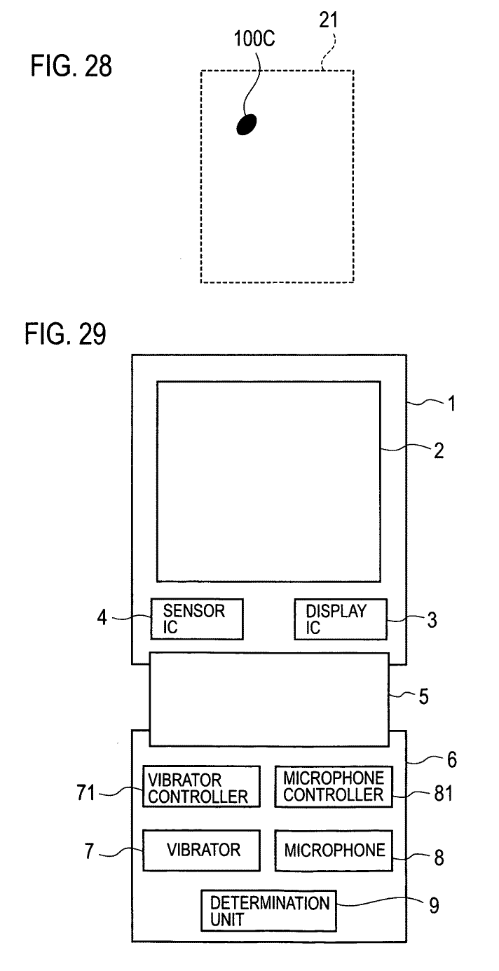

When two objects touch the display unit 2 in one point inside the active area 21 and in one point outside the active area 21 as shown in FIG. 26, a change in the capacitive coupling is detected in the conductive layers 17A and 17D as shown in FIG. 27. This detection narrows down the contact points of the objects to the positions corresponding to the conductive layers 17A and 17D. Meanwhile, an image obtained by picking up an object adjacent to the display unit 2 is shown in FIG. 28. According to these results, the contact coordinates in the conductive layer 17A can be calculated based on the result of the picked-up image shown in FIG. 28. In addition, also based the result of the picked-up image shown in FIG. 28, the contact in the conductive layer 17D can be narrowed down to a contact in a “place outside the active area.”

As such, when the position coordinates of an object is calculated not only by using an electrostatic method, but also by using an optical method with picked-up images, the contact coordinates of an object can be calculated more accurately. In addition, in the third embodiment, the conductive layers are formed to cover places outside the active area 21. This makes it possible to detect the contact of an object in an area of the conductive layer that is used to perform detection with the electrostatic method, but is not provided with a photosensor.

Note that, the conductive layer may be further divided into a larger number of patterns. Apart of wirings such as a lead may be replaced with a low resistance wiring made of silver of the like. Each of the conductive layers 17A, 17B, 17C and 17D may be driven simultaneously or driven successively. When the conductive layers 17A, 17B, 17C and 17D are successively driven by using a lead made of ITO, the costs can be reduced. Various known methods can be used as a method for driving the conductive layer.

An area of the conductive layer can be made relatively large in the configuration of determining a conductive layer touched by an object in the electrostatic method, and then of determining the contact point by narrowing down the range of the determined conductive layer in the optical method. This configuration is more advantageous for the detection of an approach of a finger before contact. Various known methods can be used as a specific method for detecting that a finger is approaching the conductive layer.

### Fourth Embodiment

A display device shown in FIG. 29 according to a fourth embodiment includes a liquid crystal panel 1 and a host substrate 6 as in the case of the display device shown in FIG. 1. The liquid crystal panel 1 and the host substrate 6 are connected to each other through a flexible substrate 5. A display unit 2 formed on the liquid crystal panel 1 includes a display function that displays an image, and an optical input function that images an object approaching the display unit 2 and obtains the image.

The display device according to the fourth embodiment of the present invention includes a vibrator 7, a vibrator controller 71, a microphone 8 and a microphone controller 81, in place of the alternating current drive circuit 72 and the detection circuit 82 of the display device shown in FIG. 1. The vibrator 7 vibrates the liquid crystal panel 1 at a predetermined frequency. The microphone 8 catches a vibration sound generated in the liquid crystal panel 1. A determination unit 9 detects the strength of the frequency of the caught vibration sound, thereby determining whether or not an object touches the liquid crystal panel 1.

The same configuration as in the first embodiment is employed for a configuration of picking up an image of a pointing object such as a finger approaching the liquid crystal panel 1, and of processing the picked-up image to detect that the pointing object is likely to be approaching the display screen. The sensor IC 4 transmits a contact possibility signal to the determination unit 9 when detecting that the pointing object is likely to be approaching the display screen.

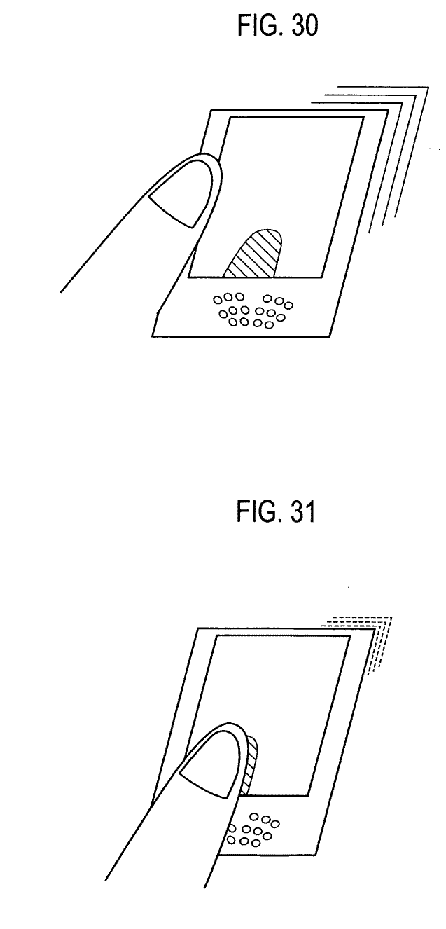

Upon receiving the contact possibility signal, the determination unit 9 activates the vibrator 7 and the microphone 8. As shown in FIG. 30, the vibrator controller 71 controls the vibrator 7 to vibrate the liquid crystal panel 1 at a certain frequency. The microphone controller 81 captures the vibration sound by using the microphone 8 and turns the signal strength of the vibration frequency component into digital signals.

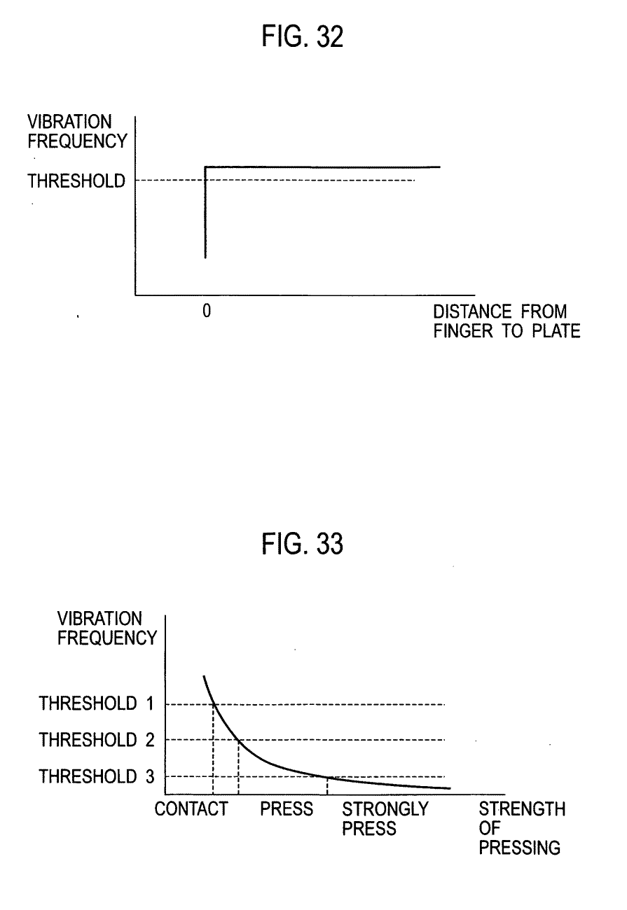

As shown in FIG. 31, when a finger touches the liquid crystal panel 1, vibration by the liquid crystal panel 1 is suppressed, so that the signal strength of the vibration frequency captured in the microphone 8 is weakened. As shown in FIG. 32, the determination unit 9 sets a threshold value for the amplitude (strength) of the vibration frequency. The determination unit 9 determines that the finger touches the liquid crystal panel 1 when the amplitude of the vibration frequency is equal to or lower than the predetermined threshold value. The coordinates of a point in the display screen touched by the finger is obtained in a way that the sensor IC 4 figures out the center of mass of the object imaged in the picked-up image. Furthermore, a strength of the pressing by the finger can be detected by setting multiple threshold values in the amplitude. In an example shown in FIG. 33, three threshold values are set to distinguish states where the finger is not in contact with, is in contact with, presses, and strongly presses, the liquid crystal panel 1.

In addition, the vibrator 7 and the microphone 8 may be formed of those incorporated in a cellular phone device. Generally, the vibrator 7 incorporated in a cellular phone device vibrates the cellular phone device to notify a user of an incoming call, instead of ringing ring alert. Thus, for the purpose of distinguishing the above-described vibration from the vibration upon receipt of a call, the frequency of the above-described vibration may be made ten or more times higher than that of the latter vibration. The microphone 8 may have higher sensitivity for making a contact determination than that in a normal time. These operations are performed only for a predetermined period, for example, one second, after the sensor IC 4 outputs the contact possibility signal. This enables reduction of power consumption.

Therefore, according to the present embodiment, an object approaching the display unit 2 is detected by referring to the image picked up by the photosensor circuit 32 of the display unit 2, and the strength of the frequency of the vibration sound is detected while the liquid crystal panel 1 is vibrated at the predetermined frequency. This makes it possible to more accurately detect the timing when the object touches the display unit 2.

What is claimed is:

1. A display device comprising:
an image display unit configured to display an image on a display screen;
an optical input unit configured to pick up an image of an object adjacent to the display screen;
a coordinate calculator configured to calculate position coordinates of the object by using the picked-up image;
a driver configured to apply any of an electric signal and physical vibration to the display screen;
a detector configured to detect a change in any of the electric signal and the vibration applied to the display screen; and
a contact determination unit configured to determine, based on the change, whether or not the object touches the display screen.

2. The display device according to claim 1, wherein
the driver applies an alternating current signal to the display screen, and
the detector detects any of an amplitude change and a phase shift of the alternating current signal.

3. The display device according to claim 2, wherein the display screen comprises a protective plate with a conductive layer to which the alternating current signal is to be applied.

4. The display device according to claim 3, comprising:
any of an adhesive layer and a portion defining a space between a display surface configured to display the image and the protective plate, and
a distance between the display surface and the protective plate changes by press pressure.

5. The display device according to claim 3, wherein the conductive layer is formed on a surface of the protective plate not to be touched by the object, and is divided into a plurality of patterns.

6. The display device according to claim 5, wherein the coordinate calculator corrects the position coordinates calculated by using position information of the conductive layer in which a contact of the object is detected.

7. The display device according to claim 1, wherein
the driver vibrates the display screen at a certain frequency, and
the detector catches vibration sound of the display screen and detects a change in a strength of a frequency component contained in the vibration sound.
